(19) United States
(12) Patent Application Publication
(10) Pub. No.: US 2007/0040868 A1
(43) Pub. Date: Feb. 22, 2007

(54) THERMAL PRINTHEAD

(75) Inventors: Takumi Yamade, Ukyo-ku (JP); Shinobu Obata, Ukyo-ku (JP)

Correspondence Address: ROHM CO., LTD.;C/O KEATING & BENNETT, LLP, 8180 GREENSBORO DRIVE, SUITE 850, MCLEAN, VA, 22102, US

(73) Assignee: ROHM CO., LTD., Ukyo-ku (JP)

(21) Appl. No.: 11/465,465

(22) Filed: Aug. 18, 2006

(30) Foreign Application Priority Data
Aug. 22, 2005 (JP) 2005-239526

(51) Int. Cl. B41J 2/05

(52) U.S. Cl. 347/61; 347/63

(57) ABSTRACT

A thermal printhead includes a ceramic substrate, a resistor layer that defines a plurality of heat-generating portions arranged in the main scanning direction, a common electrode connected to the plurality of heat-generating portions, a plurality of individual electrodes arranged in the main scanning direction, which respectively extend in the sub-scanning direction, which are electrically connected to the common electrode via the heat-generating portions, and which have pads disposed on the respective end portions thereof, a glaze layer, a protective layer covering the resistor layer, the common electrode, and the plurality of individual electrodes, a drive IC, and a plurality of wires. The protective layer has a shape that exposes the plurality of pads, and covers a band region located between the drive IC and the plurality of pads. Thus, the thermal printhead avoids any interference with a platen roller while achieving a reduction in size.

### BACKGROUND OF THE INVENTION

1. Field of the Invention

The present invention relates to a thermal printhead.

2. Description of the Related Art

A thermal printhead is used to perform printing on a recording medium such as heat-sensitive paper and thermal transfer ink ribbon, and is one of the constituent components of a printer. FIG. 5 shows one example of a conventional thermal printhead, similar to that shown in Japanese Patent Application Kokai No. 2002-127483. The thermal printhead X illustrated in this figure includes a substrate 91 that is covered by a glaze layer 92, individual electrodes 93, a common electrode 94, a resistor layer 95, and a drive IC 96. The individual electrodes 93 and branch portions (not shown) that extend from the common electrode 94 are disposed alternately in a comb-tooth arrangement in the direction of depth in the figure (i.e., in the main scanning direction). The resistor layer 95 is in the form of a band extending in the main scanning direction, and is arranged so as to lie across the individual electrodes 93 and the branch portions of the common electrode 94. The drive IC 96 is used to selectively distribute power to specified portions of the resistor layer 95, and is connected to the individual electrodes 93 by wires 97. A protective layer 98 is used to protect the resistor layer 95, the common electrode 94, and the right portion of the individual electrodes 93 in the figure. When voltage is applied by the drive IC 96 to selected individual electrodes 93, power is distributed to specified portions of the resistor layer 95. Heat is generated from the specified portions of the resistor layer 95 as a result of this distributed power. Printing by the thermal printhead X is performed by this heat being transferred onto a recording medium such as heat-sensitive paper and thermal transfer ink ribbon that is pressed by a platen roller Pr.

However, such printers have recently been reduced in size dramatically. As a result, an attempt has been made to further reduce the size of the thermal printhead X as well. Accordingly, the size of the thermal printhead X has been reduced relative to the platen roller Pr. In other words, the platen roller Pr is becoming larger in diameter relative to the thermal printhead X. Then, a problem arises in that the platen roller Pr whose diameter has become relatively large interferes with the wires 97. Furthermore, in a construction including a sealing resin (not shown) for protecting the wires 97, there is a likely possibility that the platen roller Pr and the sealing resin will interfere with each other. Thus, as the size of the thermal printhead X is reduced, the interference with the platen roller Pr becomes more of a problem.

### SUMMARY OF THE INVENTION

In order to overcome the problems described above, preferred embodiments of the present invention provide a thermal printhead that does not with a platen roller, for example, while also achieving a reduction in size.

According to a preferred embodiment of the present invention, the thermal printhead includes a substrate, a resistor layer that defines a plurality of heat-generating portions arranged in a main scanning direction, a common electrode connected to the plurality of heat-generating portions, a plurality of individual electrodes arranged in the main scanning direction, which respectively extend in a sub-scanning direction, which are electrically connected to the common electrode via the plurality of heat-generating portions, and which have pads on respective end portions thereof for bonding wires thereto, a glaze layer that is interposed between the substrate and the resistor layer, the common electrode, and the plurality of individual electrodes, a protective layer that covers the resistor layer, the common electrode, and at least a portion of each of the plurality of individual electrodes, a drive IC that controls the power distribution to the plurality of heat-generating portions, and a plurality of wires that connect the pads of the plurality of individual electrodes and the drive IC, wherein the protective layer has a shape that exposes the pads of the plurality of individual electrodes, and covers a band region located between the drive IC and the plurality of pads.

In such a construction, the portion of the protective layer covering the band region makes it possible to prevent the wires from drooping down. Accordingly, it is possible to avoid undesirable electrical connection or contact of the wires to the adjacent ones of the plurality of individual electrodes. Furthermore, there is no need to form the wires in a shape that defines a large arc. This avoids the interference, for example, with the platen roller of the printer on which the thermal printhead is mounted, and also makes it possible to reduce the size of the thermal printhead.

In a preferred embodiment of the present invention, a plurality of hole portions surrounding each of the pads in the in-plane direction of the substrate are provided in the protective layer. Such a construction avoids undesirable electrical connection of the wires to the adjacent ones of the plurality of individual electrodes. Moreover, most of the end edges of the protective layer forming the hole portions contact the glaze layer. This makes it possible to increase the bonding strength of the end edge of the protective layer compared to a case in which the end edges contact the individual electrodes that are made of metal, for example, and therefore prevents the peeling of the protective layer.

In a preferred embodiment of the present invention, the gap between the end edges of the protective layer and the respective pads is about 1 μm to about 10 μm. Such a construction avoids undesirable electrical connection of the wires and also prevents the peeling of the protective layer.

In a preferred embodiment of the present invention, a sealing resin is further provided which covers at least the IC drive, the plurality of wires, and portions of the plurality of individual electrodes not covered by the protective layer. With such a construction, it is possible to protect the drive IC and the plurality of wires. Furthermore, it is not necessary to provide a dedicated protective layer for covering the plurality of individual electrodes, which is advantageous in terms of simplifying the manufacturing process.

In a preferred embodiment of the present invention, the protruding height of the sealing resin from the substrate in the thickness direction of the substrate is preferably about 0.5 mm or less. Such a construction is preferable for avoiding interference with the platen roller, for example.

In a preferred embodiment of the present invention, the protruding height of the wires from the substrate in the thickness direction of the substrate is preferably about 0.35 mm or less. Such a construction is preferable for avoiding interference with the platen roller, for example.

In a preferred embodiment of the present invention, the thickness of the plurality of pads is preferably about 0.3 μm to about 1.2 μm. With such a construction, sufficient bonding of the wires is possible.

In a preferred embodiment of the present invention, the protective layer includes SiO₂ or SiN, and the thickness thereof is about 0.6 μm to about 2.0 μm, and is preferably greater than the thickness of the plurality of pads. Such a construction is preferable for preventing the wires from undesirably drooping down while also avoiding interference of the wires with capillaries used for the bonding of the wires.

In a preferred embodiment of the present invention, an additional protective layer is further provided on the protective layer and which covers at least the resistor layer in the in-plane direction of the substrate. Such a construction makes it possible to promote the transfer of heat, for example, to heat-sensitive paper from the plurality of heat-generating portions.

In a preferred embodiment of the present invention, the drive IC is positioned to the side of the substrate in the sub-scanning direction, and is provided on an additional substrate that is positioned below a surface of the substrate on which the glaze layer is provided. Such a construction makes it possible to prevent the drive IC from greatly protruding from the ceramic substrate in the thickness direction of the substrate.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a plan view showing a first preferred embodiment of the thermal printhead according to the present invention.

FIG. 2 is a sectional view along line II-II in FIG. 1.

FIG. 3 is a partially enlarged plan view showing the area around the pads of the individual electrodes in the first preferred embodiment of the thermal printhead of the present invention.

FIG. 4 is a plan view showing a second preferred embodiment of the thermal printhead according to the present invention.

FIG. 5 is a sectional view showing one example of a conventional thermal printhead.

### DETAILED DESCRIPTION OF PREFERRED EMBODIMENTS

Preferred embodiments of the present invention will be described below in specific terms with reference to the figures.

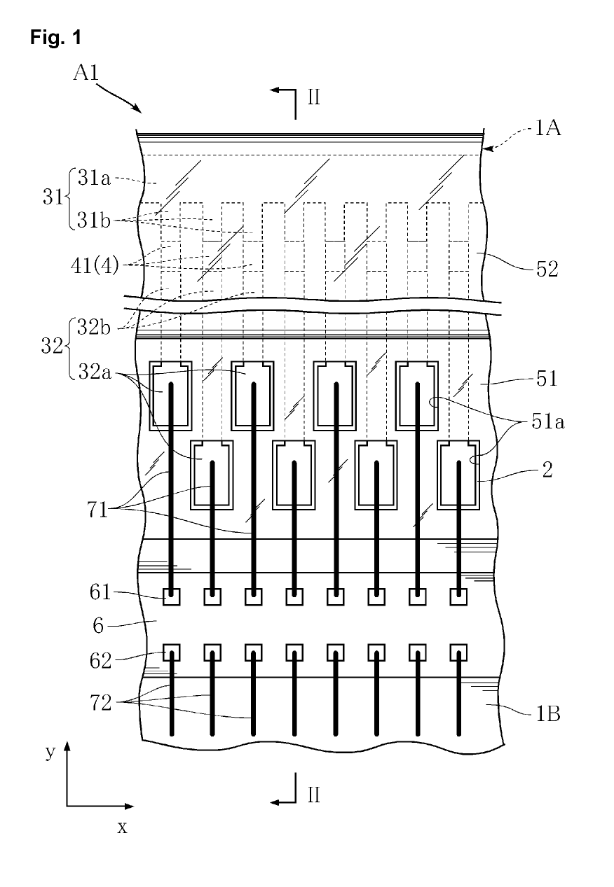

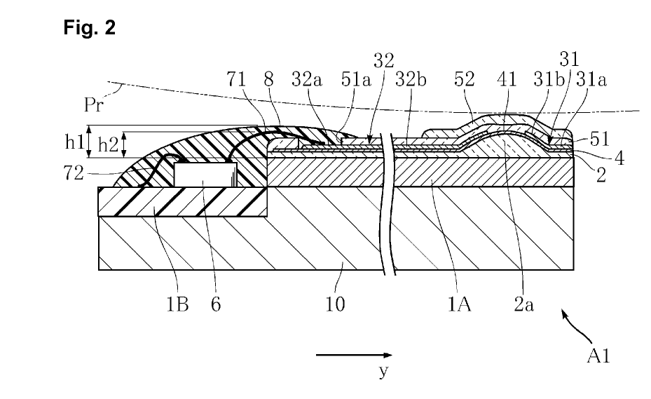

FIGS. 1 and 2 show a first preferred embodiment of the thermal printhead according to the present invention. The thermal printhead A1 of the present preferred embodiment includes a heatsink 10, a ceramic substrate 1A, a printed wiring board 1B, a glaze layer 2, a common electrode 31, a plurality of individual electrodes 32, a resistor layer 4, protective layers 51 and 52, and a drive IC 6. As is shown in FIG. 2, the thermal printhead A1 is used to perform printing, for example, on heat-sensitive paper that is supplied between the thermal printhead and a platen roller Pr disposed facing the thermal printhead. As will be described later, the thermal printhead A1 of the present preferred embodiment is a so-called thin film-type thermal printhead including a common electrode 31, a plurality of individual electrodes 32, and a resistor layer 4 that are formed as thin films. Furthermore, a sealing resin 8 is omitted in FIG. 1 for the sake of simplicity.

For example, the heatsink 10 is made of aluminum, and is used to promote heat-dissipation to the outside of the thermal printhead A1 during printing. As is shown in FIG. 2, the heatsink 10 includes two portions having different thicknesses. The ceramic substrate 1A is joined to the upper surface of the thick portion on the right side of the figure, while the printed wiring board 1B is joined to the upper surface of the thin portion on the left side of the figure.

The ceramic substrate 1A is preferably a flat, substantially rectangular plate as seen in plan view extending in the main scanning direction x in FIG. 1, and is made of, for example, alumina ceramic.

The printed wiring board 1B is preferably a flexible laminate of a resin layer and a wiring layer. As is shown in FIG. 2, the printed wiring board 1B is positioned to the side of the ceramic substrate 1A in the sub-scanning direction y, and below the level of the ceramic substrate 1A in the figure. As a result, the upper surface of the printed wiring board 1B is positioned below the level of the upper surface of the ceramic substrate 1A. A connector (not shown) is provided on the end portion (not shown) of the printed wiring board 1B. This connector is provided on the portion of the printed wiring board 1B that extends from the heatsink 10, and is used to connect the thermal printhead A1 to the printer.

As is clearly indicated in FIG. 2, the glaze layer 2 is formed on the ceramic substrate 1A. The glaze layer 2 is made of glass, for example, and is used to provide a smooth surface suitable for forming the plurality of individual electrodes 32, common electrode 31, resistor layer 4 that defines heat-generating portions 41, and the like. A protruding portion 2a that extends in the main scanning direction x is formed in the glaze layer 2. A plurality of heat-generating portions 41 are disposed on the protruding portion 2a. The protruding portion 2a causes the portion of the protective layer 52 covering the plurality of heat-generating portions 41 to surely contact the recording medium.

The resistor layer 4 is provided on the glaze layer 2, and is made of a metal such as TaSiO₂. The portions of the resistor layer 4 not covered by the common electrode 31 and the plurality of individual electrodes 32 define the plurality of heat-generating portions 41. The plurality of heat-generating portions 41 are arranged in the main scanning direction x.

The common electrode 31 and the plurality of individual electrodes 32 are provided on the resistor layer 4 and are made of metal, such as aluminum or gold, having a smaller electrical resistance than the material of the resistor layer 4. The common electrode 31 has a base portion 31a and a plurality of branch portions 31b as shown in FIG. 1. The base portion 31a extends in the main scanning direction x along the upper end of the ceramic substrate 1A, and is connected to a common line (not shown). The plurality of branch portions 31b extend in the sub-scanning direction y from the base portion 31a.

The plurality of individual electrodes 32 are arranged in the main scanning direction x, and each of these individual electrodes 32 has a pad 32a and a band portion 32b. The band portions 32b are portions that extend in the sub-scanning direction y, and these portions 32b face the branch portions 31b of the common electrode 31 on one end thereof with some separation by having the heat-generating portions 41 in between. That is, the portions of the resistor layer 4 that are located between the branch portions 31b and band portions 32b define the heat-generating portions 41. The pads 32a are connected to the other ends of the band portions 32b, and define portions used for the bonding of the wires 71. As is shown in FIG. 3, the pads 32a preferably have a substantially rectangular shape, and the thickness thereof is preferably about 0.3 μm to about 1.2 μm, for example. In the present preferred embodiment, as is shown in FIG. 1, the plurality of pads 32a are arranged in a staggered configuration in which adjacent pads in the main scanning direction x are shifted from each other in the sub-scanning direction y.

The protective layer 51 includes SiO₂ or SiN, for example, and is arranged so as to cover the heat-generating portions 41, the common electrode 31, and the portions of the plurality of individual electrodes 32 other than the plurality of pads 32a. A plurality of hole portions 51a are provided in the protective layer 51. As is shown in FIG. 3, the plurality of hole portions 51a preferably have a substantially rectangular shape, with the size of the respective hole portions being larger than that of the pads 32a, and these hole portions 51a are arranged in a staggered configuration so as to surround the pads 32a. In the present preferred embodiment, a gap s of about 1 μm to about 10 μm is provided between the protective layer 51 and pads 32a within the hole portions 51a. As a result, the portions of the glaze layer 2 that are not covered by the plurality of individual electrodes 32 or protective layer 51 are present between the pads 32a and edges of the hole portions 51a. The thickness of the protective layer 51 is preferably about 0.6 μm to about 2.0 μm, and is preferably greater than the thickness of the pads 32a.

The protective layer 52 is preferably a band made of hard glass, for example, and as is shown in FIG. 2, the protective layer 52 is arranged above the protruding portion 2a and the plurality of heat-generating portions 41 in the figure. The protective layer 52 is a portion that is pressed against the recording medium by the platen roller Pr, and is therefore made harder and less susceptible to wear than the protective layer 51.

The drive IC 6 is used to control the driving of the printing operation of the thermal printhead A1, and has the function of causing desired ones of the plurality of heat-generating portions 41 to generate heat by selectively applying voltage to the plurality of individual electrodes 32. The drive IC 6 is mounted on the printed wiring board 1B. As a result, in the present preferred embodiment, as is shown in FIG. 2, the upper surface of the printed wiring board 1B is positioned below the upper surface of the ceramic substrate 1A. As is shown in FIG. 1, a plurality of pads 61 and 62 are provided on the drive IC 6. The plurality of pads 61 and the plurality of pads 32a are connected by the plurality of wires 71. As is clearly shown in FIG. 2, the wires 71 are arranged in a circular arc shape so as to straddle the portion of the protective layer 51 that is located to the left of the pads 32a in the figure. In the present preferred embodiment, the protruding height h2 of the wires 71 from the ceramic substrate 1A is preferably about 0.35 mm or less. Additionally, the plurality of pads 62 are connected to appropriate locations on the wiring pattern (illustration omitted) on the printed wiring board 1B by a plurality of wires 72.

As is shown in FIG. 2, the sealing resin 8 is preferably made of epoxy resin colored black, for example, for the purpose of blocking visible light, and is used to protect the drive IC 6, wires 71 and 72, and plurality of pads 32a. The sealing resin 8 is arranged in a shape that bulges upward in the figure in order to sufficiently seal the wires 71 that are arranged in a circular arc shape. In the present preferred embodiment, the protruding height h1 of the sealing resin 8 from the ceramic substrate 1A is preferably about 0.5 mm or less.

The thermal printhead A1 of the present preferred embodiment can be manufactured, for example, as follows. First, a ceramic substrate 1A is prepared. Next, a glaze layer 2 made of glass is formed on the ceramic substrate 1A. Then, a thin film of TaSiO₂ is sputtered on the glaze layer 2 to form a resistor 4. Next, a thin film of aluminum or gold is sputtered so as to cover the TaSiO₂ thin film. A mask is formed using a photolithographic technique on the thin films, and etching is performed by utilizing the mask. A common electrode 31, a plurality of individual electrodes 32, and a resistor layer 4 having a plurality of heat-generating portions 41 are obtained by this patterning. Furthermore, a film of SiO₂ or SiN is formed so as to cover the electrodes 31, 32 and resistor layer 4, and a plurality of hole portions 51a are formed by performing patterning on this film. As a result, a protective layer 51 is obtained. A protective layer 52 is formed on the protective layer 51 using hard glass. Afterwards, a heatsink 10 is prepared, and the ceramic substrate 1A that has gone through the steps described above and a printed wiring board 1B are joined to the heatsink 10. Then, for example, a drive IC 6 is bonded to the printed wiring board 1B, and the plurality of wires 71 and 72 are bonded. A sealing resin 8 is formed by molding a black epoxy resin material so as to cover the drive IC 6, wires 71 and 72, and the like. The thermal printhead A1 is obtained by the steps described above.

Next, the action of the thermal printhead A1 will be described.

In the present preferred embodiment, as is shown in FIG. 2, the wires 71 straddle the portion of the protective layer 51 that is located to the left of the pads 32a in the figure. Therefore, there is no concern for the wires 71 undesirably contacting the adjacent individual electrodes 32 or the like even if the wires 71 droop downward during the manufacturing process. Accordingly, it is not necessary to arrange the wires 71 to have a shape that greatly extends upward in the figure, allowing the use of a shape with a small upward protruding height in the figure. Moreover, the protruding height of the sealing resin 8 that covers wires 71 can also be made small. Consequently, it is possible to avoid any interference between the sealing resin 8 and platen roller Pr, and to achieve a size reduction of the thermal printhead A1. In the present preferred embodiment, in particular, the protruding height h2 of the wires 71 in FIG. 2 is preferably about 0.35 mm or less, and the protruding height hi of the sealing resin 8 is preferably about 0.5 mm or less. These are suitable for avoiding interference with the platen roller Pr, so that a platen roller Pr having a relatively large diameter can be used.

As is shown in FIG. 3, the hole portions 51a of the protective layer 51 are disposed on the outside of the pads 32a to expose these pads 32b. Accordingly, when capillaries for bonding the wires 71 are caused to contact the pads 32a, interference between the capillaries and protective layer 51 can be prevented. Furthermore, most of the end edges of the protective layer 51 forming the hole portions 51a contact the glaze layer 2, so that the portions of protective layer 51 contacting the individual electrodes 32 are minimal. Because the protective layer 51 includes SiO₂ or SiN, the bonding strength of the protective layer 51 with the glaze layer 2 made of glass is higher than that of the individual electrodes 32 made of a metal such as aluminum or gold. Accordingly, it is possible to prevent the protective layer 51 from peeling off. Furthermore, the substantially rectangular hole portions 51a partition the adjacent individual electrodes 32 in the main scanning direction x and sub-scanning direction y, which is suitable for preventing an undesirable contact of the wires 71 with the adjacent individual electrodes 32.

Setting the thicknesses of the protective layer 51 and pads 32a at the above-described preferred values is advantageous in terms of avoiding undesirable contact of the wires 71 while also avoiding the interference between the capillaries and protective layer 51.

The position and the shape of the protective layer 52 are designed for being pressed against the platen roller Pr. As a result, heat from the heat-generating portions 41 that are positioned directly beneath the protective layer 52 in FIG. 2 can be effectively transferred, for example, to heat-sensitive paper. This is suitable for enhancing the image quality and increasing the speed of printing using the thermal printhead A1.

As is shown in FIG. 2, the printed wiring board 1B on which the drive IC 6 is mounted is disposed further downward in the figure than the ceramic substrate 1A. As a result, it is possible to prevent the drive IC 6 from protruding upward in the figure from the ceramic substrate 1A. This is beneficial for reducing the protruding height hi of the sealing resin 8 and the protruding height h2 of the wires 71.

There is absolutely no exposure of the plurality of individual electrodes 32 to the outside of the thermal printhead A1 as a result of applying the sealing resin 8. This is suitable for avoiding an undesirable contact and also preventing the deterioration of the individual electrodes 32. Furthermore, there is no need to provide a dedicated protection layer in order to avoid the exposure of the individual electrodes 32, so that the manufacturing process can be simplified.

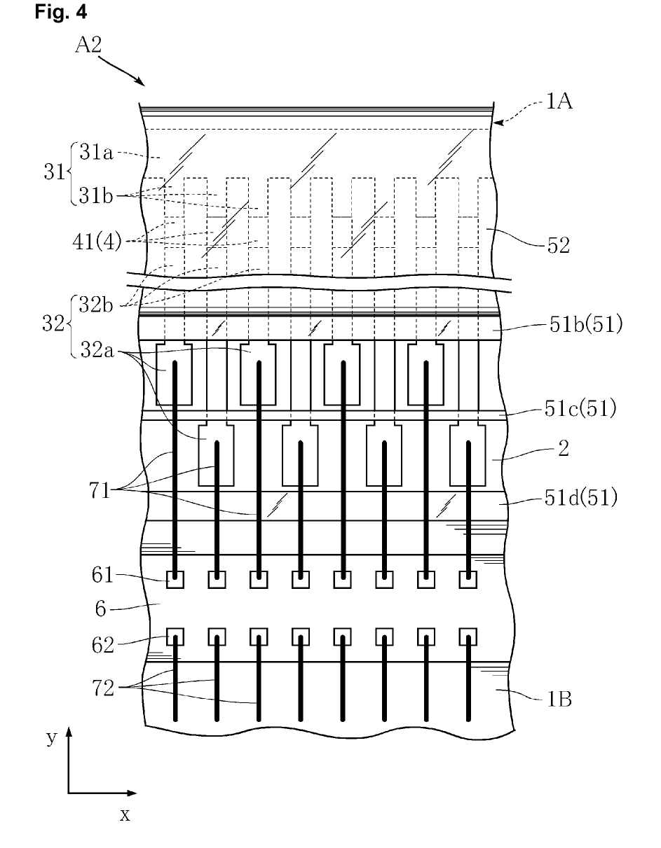

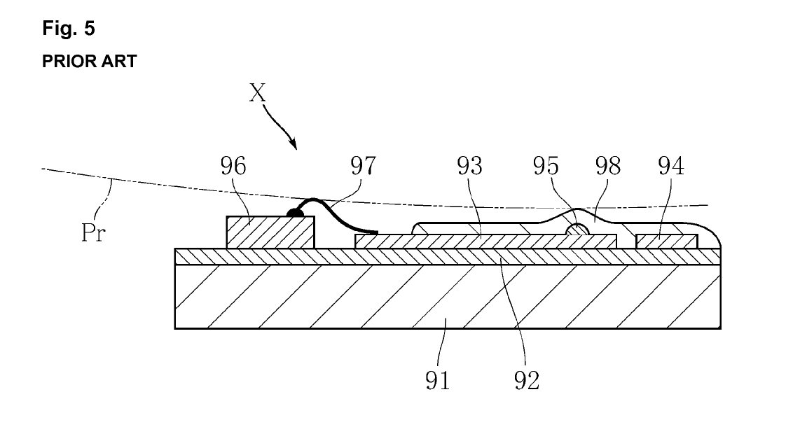

FIG. 4 shows a second preferred embodiment of the thermal printhead according to the present invention. In FIG. 4, elements that are the same as or similar to those of the first preferred embodiment are labeled with the same reference characters.

The thermal printhead A2 shown in FIG. 4 differs from the first preferred embodiment in that the protective layer 51 includes a wide area portion 51b and two band portions 51c and 51d. The wide area portion 51b covers the common electrode 31, the plurality of heat-generating portions 41, and portions of the respective band portion 32b of the plurality of individual electrodes 32. The band portions 51c and 51d extend in the main scanning direction x. The band portion 51c is disposed between the staggered arrangement of the plurality of pads 32a that are separated in the sub-scanning direction y. The band portion 51d is disposed below the plurality of pads 32a in the figure. In the present preferred embodiment as well, the band portions 51c and 51d make it possible to prevent the wires 71 from undesirably drooping down during the manufacturing process.

The thermal printhead of the present invention is not limited to the above-mentioned preferred embodiments. With regard to the specific construction of each component of the thermal printhead of the present invention, design changes can be freely made in various ways.

The shape of the pads of the individual electrodes is not limited to a substantially rectangular shape; any shape that is appropriate for wire bonding (e.g., circular arc shape) may be used. It is sufficient as long as the shape of the hole portions of the protective layer is a shape having an appropriate gap with respect to the pads of the individual electrodes. The arrangement of the pads of the individual electrodes is not limited to a staggered arrangement in two rows; for example, a staggered arrangement in three or more rows or an arrangement in a single row may also be used. The shapes and arrangements of the heat-generating portions and the common electrode and plurality of individual electrodes that are electrically connected by these heat-generating portions are not limited to those of the above-mentioned preferred embodiments. The thermal printhead of the present invention is not limited to a thin film type, and may also be constructed as a thick film-type thermal printhead in which a resistor layer, a common electrode, a plurality of individual electrodes, and the like are formed from thick films.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A thermal printhead comprising:
a substrate;
a resistor layer defining a plurality of heat-generating portions arranged in a main scanning direction;
a common electrode connected to the plurality of heat-generating portions;
a plurality of individual electrodes spaced in the main scanning direction and extending in a sub-scanning direction, the plurality of individual electrodes electrically connected to the common electrode via the plurality of heat-generating portions, and each of the plurality of individual electrodes including a pad on an end portion thereof;
a glaze layer interposed between the substrate and the resistor layer, the common electrode, and the plurality of individual electrodes;
a protective layer arranged to cover the resistor layer, the common electrode, and at least a portion of each of the plurality of individual electrodes;
a drive IC that controls power distribution to the plurality of heat-generating portions; and
a plurality of wires connecting the pads of the plurality of individual electrodes and the drive IC; wherein
the protective layer is arranged to expose the pads of the plurality of individual electrodes, and a portion of the protective layer is arranged between the drive IC and the plurality of pads.

2. The thermal printhead according to claim 1, wherein a plurality of hole portions in the protective layer expose each of the pads in an in-plane direction of the substrate.

3. The thermal printhead according to claim 2, wherein a gap between an edge of the respective hole portions and the respective pads is about 1 μm to 10 μm.

4. The thermal printhead according to claim 1, further comprising a sealing resin arranged to cover at least the IC drive, the plurality of wires, and portions of the plurality of individual electrodes not covered by the protective layer.

5. The thermal printhead according to claim 4, wherein a protruding height of the sealing resin from the substrate in a thickness direction of the substrate is about 0.5 mm or less.

6. The thermal printhead according to claim 1, wherein a protruding height of the wires from the substrate in a thickness direction of the substrate is about 0.35 mm or less.

7. The thermal printhead according to claim 1, wherein a thickness of the plurality of pads is about 0.3 μm to about 1.2 μm.

8. The thermal printhead according to claim 7, wherein the protective layer includes SiO₂ or SiN, and the thickness thereof is about 0.6 μm to about 2.0 μm, and is greater than the thickness of the plurality of pads.

9. The thermal printhead according to claim 1, further comprising an additional protective layer on the protective layer and arranged to cover at least the resistor layer in an in-plane direction of the substrate.

10. The thermal printhead according to claim 1, wherein the drive IC is positioned to a side of the substrate in the sub-scanning direction, and arranged on an additional substrate that is positioned below a surface of the substrate on which the glaze layer is provided.
